(19) United States
(12) Patent Application Publication
(10) Pub. No.: US 2025/0008957 A1
(43) Pub. Date: Jan. 9, 2025

(54) METHOD OF IMPROVING PLANT GROWTH

(71) Applicant: UPL LIMITED, Mumbai (IN)

(72) Inventors: Rajapandian Ramanathan NARAYANASAMY, Mumbai (IN); Brijesh Kumar GUPTA, Maharashtra Thane West (IN); Sunil NAGANUR, Mumbai (IN); Prabhakar SANGLE, Mumbai (IN)

(21) Appl. No.: 18/711,979

(22) PCT Filed: Nov. 23, 2022
(86) PCT No.: PCT/IB2022/061314

§ 371 Date: May 21, 2024

(30) Foreign Application Priority Data
Nov. 24, 2021 (IN) 202121054323

(51) Int. Cl. A01N 43/40; A01N 37/26; A01N 43/32; A01N 43/36; A01N 43/56; A01N 43/653; A01N 53/00; A01P 3/00; A01P 7/04

(52) U.S. Cl. CPC A01N 43/40; A01N 37/26; A01N 43/32; A01N 43/36; A01N 43/56; A01N 43/653; A01N 53/00; A01P 3/00; A01P 7/04

(57) ABSTRACT

The present invention relates to a method of improving growth of plants and/or improving germination of plants and/or seed vigour by applying a combination of flonicamid and one or more agrochemicals to said plant or plant propagation material or locus thereof. The present invention also relates to an agrochemical combination comprising flonicamid and one or more agrochemicals. More particularly, the present invention also relates to an agrochemical composition thereof.

### FIELD OF THE INVENTION

The present invention relates to flonicamid combinations for seed treatment. More particularly, the present invention relates to a method for improving plant growth and/or to a method of improving seed germination in plants by applying flonicamid combinations to said plant or to a plant propagation material or to a locus thereof. More particularly, the present invention relates to an agrochemical combination comprising flonicamid and one or more agrochemicals thereof. More particularly, the present invention also relates to an agrochemical composition comprising flonicamid and one or more agrochemicals thereof.

### BACKGROUND OF THE INVENTION

Insecticides are agents of chemical or biological origin, which are used to control insects by killing them or preventing them from engaging in behaviours deemed undesirable or destructive. Insecticides can be classified in several ways, based on their chemistry, their toxicological action, or their mode of penetration. Insecticides are applied to target pests in various formulations and delivery systems (e.g., sprays, baits, slow-release diffusion, etc.). Based on the different modes of action, most of the insecticides act upon the insect's nervous system (e.g., cholinesterase inhibition), while others act as growth regulators or endotoxins. The most used insecticides include organophosphates, pyrethroids and carbamates. Insecticides also comprise ovicides and larvicides, which are used against insect eggs and larvae, respectively. It is important to understand the modes of action as this can aid in the identification of a particular cause to be addressed.

Insecticides designed to permeate plants from within-systemic insecticides-move through the plants and may be present in all tissues after application. Systemic insecticides are absorbed by and transported through plants and may render some or all of the plant toxic to insects that feed on the plant tissue. Flonicamid (N-cyanomethyl-4-trifluoromethylnicotinamide), a pyridine carboxamide compound, is a systemic insecticide. It possesses selective activity against hemipterous pests, such as aphids and whiteflies, and thysanopterous pests. Flonicamid is very active against aphids, regardless of differences in species, stages of development and morphs. It disrupts the insect's chordotonal organs that can affect hearing, balance, and movement to cause cessation of feeding, but the specific target site of the chemical is unknown. Therefore, flonicamid is a known insecticide and is typically sold as wettable granules to be mixed with water before spraying. It has been used alone or in combination with various other agents to control the insect population in plants.

In order to improve the agriculture output and agricultural practices, only controlling the pests does not suffice. Increase in yield and vigour, and reduced phytotoxicity are some of the other aspects that are important for increased agricultural produce. To obtain these results, the insecticides and other chemical pesticides are used along with fertilizers, plant growth regulators (PGRs) and other agents. Although, these agents provide the desired results, they alter the soil health and cause harm to the environment at the same time. In addition to that, they also increase the monetary burden on the farmers.

Thus, there is a continuous need for finding improved ways to enhance the plant growth and provide increased resistance and vitality to the plants. There is also a further need in the art to reduce the planting shock to plants for achieving the same results as stated above. There is a further need in the art for the reduction of fertilizers and other chemical agents for achieving sustainable agricultural practices.

### OBJECTIVES OF THE INVENTION

It is a primary objective of the present invention to provide a method for improving the plant growth by applying flonicamid combination to said plant or a plant propagation material or to a locus thereof.

It is another objective of the present invention to provide a method for improving the plant vigour by applying flonicamid combination to said plant or to a plant propagation material or to a locus thereof.

It is a further objective of the present invention to provide an agrochemical combination comprising flonicamid and one or more agrochemicals thereof.

It is yet another objective of the present invention to provide an agrochemical composition comprising flonicamid and one or more agrochemicals thereof.

### SUMMARY OF THE INVENTION

In one aspect of the present invention, the invention provides a method for improving the germination of a seed or a plant or a plant propagation material by applying flonicamid and one or more agrochemicals to said seed or plant or plant propagation material or a locus thereof.

In another aspect, the present invention provides a method for improving the germination of a seed or a plant or a plant propagation material by applying flonicamid and one or more agrochemicals comprising pesticides, fungicides, insecticides, and herbicides to said seed or plant or plant propagation material or the locus thereof.

In another aspect, the present invention provides use of flonicamid to improve the growth of a plant by applying flonicamid and one or more agrochemicals comprising pesticides, fungicides, insecticides, and herbicides to said plant or plant propagation material or the locus thereof.

In yet another aspect, the present invention provides use of flonicamid to improve the vigour of plant by applying flonicamid and one or more agrochemicals comprising pesticides, fungicides, insecticides, and herbicides to said plant or plant propagation material or the locus thereof.

In another aspect, the present invention provides an agrochemical combination comprising flonicamid and one or more agrochemicals thereof.

In yet another aspect, the present invention provides an agrochemical composition comprising flonicamid and one or more agrochemicals thereof.

Additional features and advantages of the present invention will be apparent from the detailed description that follows, which illustrates by way of example, the most preferred features of the present invention which are not to be construed as limiting the scope of the invention described herein.

### DETAILED DESCRIPTION OF THE INVENTION

Those skilled in art will be aware that the invention described herein is subject to variations and modifications other than those specifically described. It is to be understood that the invention described herein includes all such variations and modifications. The invention also includes all such steps, features, compositions, and methods referred to or indicated in this specification, individually or collectively, and any and all combinations of any two or more said steps or features.

For the purposes of the following detailed description, it is to be understood that the invention may assume various alternative variations except where explicitly specified to be contrary. Moreover, other than in any operating examples, or where otherwise indicated, all numbers expressing, for example, quantities of materials/ingredients used in the specification are to be understood as being modified in all instances by the term “about”.

### Definitions

As used herein, the terms “comprising” “including,” “having,” “containing,” “involving,” and the like are to be understood to be open-ended, i.e., to mean including but not limited to. The terms “preferred” and “preferably” refer to embodiments of the invention that may afford certain benefits, under certain circumstances.

In any aspect or embodiment described hereinbelow, the phrase comprising may be replaced by the phrases “consisting of” or “consisting essentially of” or “consisting substantially of”. In these aspects or embodiment, the composition described includes or comprises or consists of or consists essentially of or consists substantially of the specific components recited therein, to the exclusion of other ingredients or excipients not specifically recited therein.

The term ‘plant’ refers to all physical parts of a plant, including seeds, seedlings, saplings, roots, tubers, stems, stalks, foliage, and fruits. The term plant includes transgenic and non-transgenic plants.

The term “locus” of a plant as used herein is intended to embrace the place on which the plants are growing, where the plant propagation materials of the plants are sown or where the plant propagation materials of the plants will be placed into the soil.

The term “plant propagation material” is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion.

The term “agrochemical” used herein is understood to denote an agricultural chemical such as pesticides, fungicides, insecticides, acaricides, herbicides, nematicides, plant growth regulators and can be used interchangeably.

The term “active ingredient” (a.i.) or “active agent” used herein refers to that component of the composition responsible for control of diseases.

The terms “excipient” or “additive” mean inactive substance that forms a part of the composition. The terms “excipient” or “additive” mean essentially the same thing and can be used interchangeably.

As used herein, the term “pre-emergence” refers to the time point before seedlings emerge from the ground. When any herbicide is applied at pre-emergence stage, it prevents establishment of the germinated weed seedlings.

As used herein, the term “post-emergence” refers to the time point after seedlings emerge from the ground. When any herbicide is applied at post-emergence stage, it prevents growth of the germinated weed seedlings.

The inventors of the present invention surprisingly found that when a seed is contacted with a combination comprising flonicamid and one or more agrochemicals, the grown seedling showed an unexpected increase in the germination rate and an enhanced growth in the plant was observed indicating improved vigour. Hitherto, combinations of flonicamid and one or more agrochemicals have not been used for seed treatment purposes to obtain enhanced plant growth. Therefore, these advantages accruing from the use of flonicamid, and one or more agrochemicals were unexpected and surprising.

The present invention thus provides a method comprising applying flonicamid and one or more agrochemicals to a plant or to its locus or to a plant propagation material thereof.

In an embodiment, the present invention provides a method comprising applying flonicamid and one or more agrochemicals to a plant or its locus to improve plant growth.

In an embodiment, the present invention provides a method comprising contacting flonicamid and one or more agrochemicals to a plant propagation material to improve plant growth.

In an embodiment, the present invention provides a method comprising contacting flonicamid and one or more agrochemicals to seeds of a crop to improve seed vigour.

In accordance with the present disclosure, improved plant growth refers to an increase in root length, shoot length, seedling weight, biomass production, seed germination index as well as reduction in phytotoxicity and other such properties that indicate healthy plant growth relative to plants which have not been treated by agrochemical combinations comprising flonicamid and one or more agrochemicals.

In an embodiment, the present method is employed for improving plant growth in the absence of insect pest pressure that includes situations in which insect pests are not present in the growth area of a plant, as well as situations where such insect pests are present within the growth area of a plant but in a quantity, which is not harmful to the plant, and which does not interfere with the growth of the plant.

In an embodiment, the present invention provides a method comprising applying flonicamid and one or more agrochemicals comprising pesticides, fungicides, insecticides, herbicides or acaricides to a locus of a plant to improve plant growth.

In an embodiment, the present invention provides a method comprising contacting flonicamid and one or more agrochemicals comprising pesticides, fungicides, insecticides, herbicides or acaricides to the surface of plant propagation material to improve plant growth.

In an embodiment, the present invention provides a method comprising contacting flonicamid and one or more agrochemicals comprising pesticides, fungicides, insecticides, herbicides or acaricides to seeds of a crop to improve seed vigour.

In an embodiment, the present invention provides a method comprising applying a composition comprising flonicamid and one or more agrochemicals comprising pesticides, fungicides, insecticides, herbicides or acaricides to a plant or to its locus or to a plant propagation material to improve plant growth and/or to improve seed vigour.

In an embodiment, the composition is a suspension concentrate or an emulsifiable concentrate formulation comprising flonicamid and one or more agrochemicals comprising pesticides, fungicides, insecticides, herbicides or acaricides.

In an embodiment, the present method is used to improve plant vigour when flonicamid and one or more agrochemicals comprising pesticides, fungicides, insecticides, herbicides or acaricides is applied to either the plant, or to its locus or to a plant propagation material.

In an embodiment, the present invention provides a method of improving seed germination by applying flonicamid and one or more agrochemicals comprising pesticides, fungicides, insecticides, herbicides or acaricides to said plant or to its locus or to a plant propagation material.

In an embodiment, the method of the present invention improves the growth rate of a plant when flonicamid and one or more agrochemicals comprising pesticides, fungicides, insecticides, herbicides or acaricides is applied to either said plant or to its locus or to a plant propagation material.

In an embodiment, the method of the present invention provides an enhanced greening to the plant or its locus or a plant propagation material contacted with flonicamid and one or more agrochemicals comprising pesticides, fungicides, insecticides, herbicides or acaricides.

In an embodiment, the present invention provides use of the present method for enhancing greening in crop plants, the method comprising applying flonicamid and one or more agrochemicals comprising pesticides, fungicides, insecticides, herbicides or acaricides to a plant or to its locus or to a plant propagation material thereof.

The preferred plants or its locus or the plant propagation material which may be treated using the method of the present invention include brassicas, such as broccoli, Chinese broccoli, Brussels sprouts, cauliflower, Cavalo broccoli, kohlrabi, cabbage, Chinese cabbage and Chinese mustard cabbage; cilantro; coriander; corn, cucurbits, such as chayote, Chinese wax gourd, citron melon, cucumber, gherkin, gourd, muskmelons (including cantaloupe, casaba, crenshaw melon, golden pershaw melon, honeydew melon, honey balls, mango melon, Persian melon, pineapple melon, Santa Claus melon and snake melon), pumpkins, summer squash, winter squash and watermelon; dried beans and peas, including bean, field bean, kidney bean, lima bean, pinto bean, navy bean, tepary bean, adzuki bean, black-eyed pea, catjang, cowpea, crowder pea, moth bean, mung bean, rice bean, southern pea, urd bean, broad bean, chickpea, guar, lablab bean, lentil, pea, field pea and pigeon pea; eggplant; lettuce; leafy brassicas/turnip greens including broccoli raab, bok choy, collards, kale, mizuna, mustard spinach, rape greens and turnip greens; okra; peppers; sod; soybeans; spinach; succulent peas and beans including pea, dwarf pea, edible-pod pea, English pea, garden pea, green pea, snow pea, sugar snap pea, [pigeon pea, bean, broad bean, lima bean, runner bean, snap bean, wax bean, asparagus bean, yard long bean, jack bean and sword bean; tobacco; tomatoes; and tuberous and corm vegetables including potato, sweet potato, arracacha, arrowroot, Chinese artichoke, Jerusalem artichoke, edible canna, cassava, chayote, chufa, dasheen, ginger, leren, tanier, turmer, yam bean and true yam.

In an embodiment, the plant propagation material is a seed.

In another embodiment, the present invention relates to a method for improving plant growth by applying an agrochemical combination comprising flonicamid and one or more agrochemicals, simultaneously or sequentially, to a plant or a locus thereof or a plant propagation material thereof.

In a preferred embodiment, the present invention provides a method comprising applying flonicamid and one or more pesticides to a locus of a plant to improve plant growth.

In a preferred embodiment, the present invention provides a method comprising applying flonicamid and one or more pesticides to the surface of plant propagation material to improve plant growth.

In a preferred embodiment, the present invention provides a method comprising applying flonicamid and one or more pesticides to seeds of a crop to improve seed vigour.

In a preferred embodiment, the present invention provides a method comprising applying flonicamid and one or more fungicides to a locus of a plant to improve plant growth.

In a preferred embodiment, the present invention provides a method comprising applying flonicamid and one or more fungicides to the surface of plant propagation material to improve plant growth.

In a preferred embodiment, the present invention provides a method comprising applying flonicamid and one or more fungicides to seeds of a crop to improve seed vigour.

In an embodiment, the fungicide is from the group comprising phenyl amides, hydroxy-(2-amino-)pyrimidines, isoxazoles, isothiazolones, carboxylic acids, methyl benzimidazole carbamates, phenyl carbamates, benzamides, thiazole carboxamides, phenylureas, benzamides, cyanoacrylates, aryl-phenyl ketones, pyrimidinamines, quinazoline, de-methylation inhibitors, succinate-dehydrogenase inhibitors, quinone outside Inhibitors, quinone inside Inhibitors, organo tin compounds, thiophene carboxamides, anilino pyrimidines, phenyl pyrroles, dicarboximides, enopyranuronic acid antibiotic, hexopyranosyl antibiotic, glucopyranosyl antibiotic, tetracycline antibiotic and other such groups of fungicides.

In an embodiment, the fungicide is from the group comprising phenyl amides, isoxazoles, isothiazolones, succinate-dehydrogenase inhibitors, quinone outside Inhibitors, quinone inside Inhibitors, phenyl pyrroles.

In an embodiment, the fungicide is phenyl amides comprising benalaxyl, benalaxyl-M, furalaxyl, metalaxyl and metalaxyl-M, oxadixyl, ofurace.

In an embodiment, the fungicide is metalaxyl.

In an embodiment, the fungicide is metalaxyl-M.

In an embodiment, the fungicide is a succinate-dehydrogenase inhibitor comprising benodanil, flutolanil, mepronil, isofetamid, fluopyram, cyclobutrifluram, fenfuram, carboxin, oxycarboxin, thifluzamide, benzovindiflupyr, bixafen, fluindapyr, fluxapyroxad, furametpyr, inpyrfluxam isopyrazam, penflufen, penthiopyrad, sedaxane, soflucypram, pydiflumetofen, boscalid and pyraziflumid.

In an embodiment, the fungicide is flutolanil.

In an embodiment, the fungicide is oxycarboxin.

In an embodiment, the fungicide is carboxin.

In an embodiment, the fungicide is fluindapyr.

In an embodiment, the fungicide is fluxapyroxad.

In an embodiment, the fungicide is inpyrfluxam.

In an embodiment, the fungicide is a phenyl pyrrole comprising fenpiclonil and fludioxonil.

In an embodiment, the fungicide is fludioxonil.

In an embodiment, the fungicide is a de-methylation inhibitor comprising piperazines, pyridines, pyrimidines, imidazoles, triazoles and triazolinthiones.

In an embodiment, the fungicide is azaconazole, bitertanol, bromuconazole, cyproconazole, difenoconazole, diniconazole, epoxiconazole, etaconazole, fenbuconazole, flusilazole, fluquinconazole, flutriafol, hexaconazole, imibenconazole, ipconazole, mefentrifluconazole, metconazole, myclobutanil, penconazole, propiconazole, simeconazole, tebuconazole, tetraconazole, triadimefon, triadimenol, triticonazole, prothioconazole, imazalil, oxpoconazole, pefurazoate, prochloraz, triflumizole, fenarimol, nuarimol, pyrifenox pyrisoxazole and triforine.

In an embodiment, the fungicide is difenoconazole.

In an embodiment, the fungicide is ipconazole.

In an embodiment, the fungicide is triflumizole.

In an embodiment, the fungicide is prothioconazole.

In an embodiment, the fungicide is tebuconazole.

In an embodiment, the fungicide is a quinone inside inhibitor comprising Cyazofamid, amisulbrom, fenpicoxamid and florylpicoxamid.

In an embodiment, the fungicide is fenpicoxamid.

In an embodiment, the fungicide is cyazofamid.

In a preferred embodiment, the present invention provides a method comprising applying flonicamid and metalaxyl to a locus of a plant to improve plant growth.

In a preferred embodiment, the present invention provides a method comprising applying flonicamid and metalaxyl to the surface of plant propagation material to improve plant growth.

In a preferred embodiment, the present invention provides a method comprising applying flonicamid and metalaxyl to seeds of a crop to improve seed vigour.

In a preferred embodiment, the present invention provides a method comprising applying flonicamid and carboxin to a locus of a plant to improve plant growth.

In a preferred embodiment, the present invention provides a method comprising applying flonicamid and carboxin to the surface of plant propagation material to improve plant growth.

In a preferred embodiment, the present invention provides a method comprising applying flonicamid and carboxin to seeds of a crop to improve seed vigour.

In a preferred embodiment, the present invention provides a method comprising applying flonicamid and fludioxonil to a locus of a plant to improve plant growth.

In a preferred embodiment, the present invention provides a method comprising applying flonicamid and fludioxonil to the surface of plant propagation material to improve plant growth.

In a preferred embodiment, the present invention provides a method comprising applying flonicamid and fludioxonil to seeds of a crop to improve seed vigour.

In a preferred embodiment, the present invention provides a method comprising applying flonicamid and ipconazole to a locus of a plant to improve plant growth.

In a preferred embodiment, the present invention provides a method comprising applying flonicamid and ipconazole to the surface of plant propagation material to improve plant growth.

In a preferred embodiment, the present invention provides a method comprising applying flonicamid and ipconazole to seeds of a crop to improve seed vigour.

In a preferred embodiment, the present invention provides a method comprising applying flonicamid and one or more insecticides to a locus of a plant to improve plant growth.

In a preferred embodiment, the present invention provides a method comprising applying flonicamid and one or more insecticides to the surface of plant propagation material to improve plant growth.

In a preferred embodiment, the present invention provides a method comprising applying flonicamid and one or more insecticides to seeds of a crop to improve seed vigour.

In an embodiment, the insecticide is from one or more of Acetylcholinesterase (AChE) inhibitors, Ryanodine receptor modulators, GABA-gated chloride channel blockers, Sodium channel modulators, Nicotinic acetylcholine receptor (nAChR) competitive modulators, Glutamate-gated chloride channel (GluCI) allosteric modulators, Chordotonal organ TRPV channel modulators, Inhibitors of mitochondrial ATP synthase, Mite growth inhibitors affecting CHS1, moulting disruptors, Microbial disruptors of insect midgut membranes, Inhibitors of acetyl CoA carboxylase, Mitochondrial complex electron transport inhibitors, Ecdysone receptor agonists, Inhibitors of chitin biosynthesis.

In an embodiment, the insecticide is from one or more of Ryanodine receptor modulator comprising Chlorantraniliprole, Cyantraniliprole, Cyclaniliprole Flubendiamide, Tetraniliprole.

In an embodiment, the insecticide is Chlorantraniliprole.

In an embodiment, the insecticide is Cyantraniliprole.

In an embodiment, the insecticide is from one or more of Acetylcholinesterase (AChE) inhibitors comprising carbamates and organophosphates.

In an embodiment, the insecticide is from one or more of Nicotinic acetylcholine receptor (nAChR) competitive modulators, comprising Neonicotinoids comprising Acetamiprid, Clothianidin, Dinotefuran, Imidacloprid, Nitenpyram, Thiacloprid, and Thiamethoxam.

In an embodiment, the insecticide is from one or more of Sodium channel modulators comprising pyrethroids and pyrethrins comprising Acrinathrin, Allethrin, d-cis-trans Allethrin, dtrans Allethrin, Bifenthrin, Bioallethrin, Bioallethrin S-cyclopentenyl isomer, Bioresmethrin, Cycloprothrin, Cyfluthrin, betaCyfluthrin, Cyhalothrin, lambda-Cyhalothrin, gamma-Cyhalothrin, Cypermethrin, alphaCypermethrin, beta-Cypermethrin, thetacypermethrin, zeta-Cypermethrin, Cyphenothrin, (1R)-trans-isomers], Deltamethrin, Empenthrin (EZ)-(1R)-isomers], Esfenvalerate, Etofenprox, Fenpropathrin, Fenvalerate, Flucythrinate, Flumethrin, tau-Fluvalinate, Halfenprox, Imiprothrin, Kadethrin, Permethrin, Phenothrin [(1R)-trans-isomer], Prallethrin, Pyrethrins (pyrethrum), Resmethrin, Silafluofen, Tefluthrin, Tetramethrin, Tetramethrin [(1R)-isomers], Tralomethrin, Transfluthrin.

In an embodiment, the insecticide is Deltamethrin.

In an embodiment, the insecticide is Bifenthrin.

In a preferred embodiment, the present invention provides a method comprising applying flonicamid and Chlorantraniliprole to a locus of a plant to improve plant growth.

In a preferred embodiment, the present invention provides a method comprising applying flonicamid and Chlorantraniliprole to the surface of plant propagation material to improve plant growth.

In a preferred embodiment, the present invention provides a method comprising applying flonicamid and Chlorantraniliprole to seeds of a crop to improve seed vigour.

In a preferred embodiment, the present invention provides a method comprising applying flonicamid and Cyantraniliprole to a locus of a plant to improve plant growth.

In a preferred embodiment, the present invention provides a method comprising applying flonicamid and Cyantraniliprole to the surface of plant propagation material to improve plant growth.

In a preferred embodiment, the present invention provides a method comprising applying flonicamid and Cyantraniliprole to seeds of a crop to improve seed vigour.

In a preferred embodiment, the present invention provides a method comprising applying flonicamid and one or more herbicides to a locus of a plant to improve plant growth.

In a preferred embodiment, the present invention provides a method comprising applying flonicamid and one or more herbicides to the surface of plant propagation material to improve plant growth.

In a preferred embodiment, the present invention provides a method comprising applying flonicamid and one or more herbicides to seeds of a crop to improve seed vigour.

In a preferred embodiment, the herbicide is one or more of Lipid Biosynthesis Inhibitors, Amino Acid Biosynthesis Inhibitors, Cell Division Inhibitors, Synthetic Auxins, Photosynthesis Inhibitors, EPSP Synthase Inhibitor and Membrane Disruptors.

In a preferred embodiment, the herbicide is a EPSP Synthase Inhibitor comprising glyphosate.

In a preferred embodiment, the present invention provides a method comprising applying flonicamid and glyphosate to a locus of a plant to improve plant growth.

In a preferred embodiment, the present invention provides a method comprising applying flonicamid and glyphosate to the surface of plant propagation material to improve plant growth.

In a preferred embodiment, the present invention provides a method comprising applying flonicamid and glyphosate to seeds of a crop to improve seed vigour.

Thus, in yet another aspect the present invention provides the use of flonicamid and one or more agrochemicals to improve plant growth by applying flonicamid and one or more agrochemicals comprising pesticides, fungicides, insecticides, or herbicides to said plant or plant propagation material or the locus thereof, wherein an effective amount of flonicamid is used.

In another embodiment, the present invention provides an agrochemical combination for improving plant growth comprising flonicamid and one or more agrochemicals, wherein weight ratio of flonicamid to said one or more agrochemicals ranges from 1:1 to 100:1.

In a preferred embodiment, the weight ratio of flonicamid to said one or more agrochemicals is selected from ratios comprising 1:1, 10:1, 20:1, 30:1, 40:1, 50:1, 60:1, 70:1, 80:1, 90:1 and 100:1.

In a preferred embodiment, the weight ratio of flonicamid to said one or more agrochemicals ranges from 1:1 to 50:1.

In a preferred embodiment, the weight ratio of flonicamid to said one or more agrochemicals ranges from 1:1 to 30:1.

In a preferred embodiment, the weight ratio of flonicamid to said one or more agrochemicals is 15:1.

In a preferred embodiment, said one or more agrochemicals are selected from a group comprising of ipconazole, fludioxonil, carboxin, metalaxyl, chlorantraniliprole, and cyantraniliprole. The one or more agrochemicals are present in combination with flonicamid.

In a preferred embodiment, the weight ratio of flonicamid to ipconazole is 14.4:1.

In a preferred embodiment, the weight ratio of flonicamid to fludioxonil is 14.4:1.

In a preferred embodiment, the weight ratio of flonicamid to carboxin is 1.2:1.

In a preferred embodiment, the weight ratio of flonicamid to metalaxyl is 4.8:1.

In a preferred embodiment, the weight ratio of flonicamid to chlorantraniliprole is 1:1.

In a preferred embodiment, the weight ratio of flonicamid to chlorantraniliprole is 2:1.

In a preferred embodiment, the weight ratio of flonicamid to cyantraniliprole is 2:1.

In a preferred embodiment, flonicamid is present in a concentration range of 50-500 g/L and said one or more agrochemicals are present in a concentration range of 10-400 g/L.

In a preferred embodiment, flonicamid is present in a concentration range of 50-500 g/L.

In a preferred embodiment, flonicamid is present at a concentration of 360 g/L.

In a preferred embodiment, flonicamid is present at a concentration of 240 g/L.

In a preferred embodiment, one or more agrochemicals are present in a concentration range of 10-400 g/L.

In a preferred embodiment, one or more agrochemicals are present in a concentration range of 10-250 g/L.

In a preferred embodiment, ipconazole is present at a concentration of 25 g/L.

In a preferred embodiment, chlorantraniliprole is present at a concentration of 120 g/L.

In a preferred embodiment, chlorantraniliprole is present at a concentration of 240 g/L.

In a preferred embodiment, fludioxonil is present at a concentration of 25 g/L.

In a preferred embodiment, carboxin is present at a concentration of 200 g/L.

In a preferred embodiment, metalaxyl is present at a concentration of 50 g/L.

In a preferred embodiment, cyantraniliprole is present at a concentration of 120 g/L.

It was further surprising that the growth rate of the plant or of the plant propagation material was enhanced when flonicamid and one or more agrochemicals was applied to the plant propagation material.

In yet another aspect the present invention provides use of flonicamid to improve vigour of plant by applying flonicamid and one or more agrochemicals to said plant or plant propagation material or the locus thereof, wherein an effective amount of flonicamid and one or more agrochemicals is used.

In another aspect the present invention provides the use of flonicamid and one or more agrochemicals to improve the germination of seed by applying flonicamid and one or more agrochemicals to said seed or other plant propagation material or the locus thereof wherein an effective amount of flonicamid and one or more agrochemicals is used.

In another embodiment, the use of flonicamid and one or more agrochemicals to enhance the plant growth or germination or vigour is provided by coating the seed or plant or plant propagation material with flonicamid and one or more agrochemicals.

In the practice of the present invention, flonicamid and one or more agrochemicals may be employed in the form of technical material or in the form of any standard agriculturally acceptable formulation thereof.

In an embodiment, a seed or plant or plant propagation material is contacted with flonicamid and one or more agrochemicals comprising pesticides, fungicides, insecticides, or herbicides in the form of a suspension concentrate, emulsifiable concentrate or any other suitable liquid formulation that can coat the seed or plant or plant propagation material.

In yet another aspect the present invention provides use of flonicamid and ipconazole to improve vigour of plant by applying flonicamid and ipconazole and one or more agrochemicals to said plant or plant propagation material or the locus thereof, wherein an effective amount of Flonicamid and ipconazole is used.

In another aspect the present invention provides the use of flonicamid and ipconazole and one or more agrochemicals to improve the germination of seed by applying flonicamid and ipconazole to said seed or other plant propagation material or the locus thereof wherein an effective amount of flonicamid and ipconazole is used.

In another embodiment, the use of flonicamid and ipconazole to enhance the plant growth or germination or vigour is provided by coating the seed or plant or plant propagation material with flonicamid and ipconazole.

In the practice of the present invention, flonicamid and ipconazole may be employed in the form of technical material or in the form of any standard agriculturally acceptable formulation thereof.

In an embodiment, a seed or plant or plant propagation material is contacted with flonicamid and ipconazole in the form of a suspension concentrate, emulsifiable concentrate or any other suitable liquid formulation that can coat the seed or plant or plant propagation material.

In yet another aspect the present invention provides use of flonicamid and carboxin to improve vigour of plant by applying flonicamid and carboxin one or more agrochemicals to said plant or plant propagation material or the locus thereof, wherein an effective amount of flonicamid and carboxin is used.

In another aspect the present invention provides the use of flonicamid and carboxin and one or more agrochemicals to improve the germination of seed by applying flonicamid and carboxin to said seed or other plant propagation material or the locus thereof wherein an effective amount of flonicamid and carboxin is used.

In another embodiment, the use of flonicamid and carboxin to enhance the plant growth or germination or vigour is provided by coating the seed or plant or plant propagation material with flonicamid and carboxin.

In the practice of the present invention, flonicamid and carboxin may be employed in the form of technical material or in the form of any standard agriculturally acceptable formulation thereof.

In an embodiment, a seed or plant or plant propagation material is contacted with flonicamid and carboxin in the form of a suspension concentrate, emulsifiable concentrate or any other suitable liquid formulation that can coat the seed or plant or plant propagation material.

In yet another aspect the present invention provides use of flonicamid and fludioxonil to improve vigour of plant by applying flonicamid and fludioxonil one or more agrochemicals to said plant or plant propagation material or the locus thereof, wherein an effective amount of flonicamid and fludioxonil is used.

In another aspect the present invention provides the use of flonicamid and fludioxonil and one or more pesticides to improve the germination of seed by applying flonicamid and fludioxonil to said seed or other plant propagation material or the locus thereof wherein an effective amount of flonicamid and fludioxonil is used.

In another embodiment, the use of flonicamid and fludioxonil to enhance the plant growth or germination or vigour is provided by coating the seed or plant or plant propagation material with flonicamid and fludioxonil.

In the practice of the present invention, flonicamid and fludioxonil may be employed in the form of technical material or in the form of any standard agriculturally acceptable formulation thereof.

In an embodiment, a seed or plant or plant propagation material is contacted with flonicamid and fludioxonil in the form of a suspension concentrate, emulsifiable concentrate or any other suitable liquid formulation that can coat the seed or plant or plant propagation material.

In yet another aspect the present invention provides use of flonicamid and chlorantraniliprole to improve vigour of plant by applying flonicamid and chlorantraniliprole one or more agrochemicals to said plant or plant propagation material or the locus thereof, wherein an effective amount of flonicamid and chlorantraniliprole is used.

In another aspect the present invention provides the use of flonicamid and chlorantraniliprole and one or more agrochemicals to improve the germination of seed by applying flonicamid and chlorantraniliprole to said seed or other plant propagation material or the locus thereof wherein an effective amount of flonicamid and chlorantraniliprole is used.

In another embodiment, the use of flonicamid and chlorantraniliprole to enhance the plant growth or germination or vigour is provided by coating the seed or plant or plant propagation material with flonicamid and chlorantraniliprole.

In the practice of the present invention, flonicamid and chlorantraniliprole may be employed in the form of technical material or in the form of any standard agriculturally acceptable formulation thereof.

In an embodiment, a seed or plant or plant propagation material is contacted with flonicamid and chlorantraniliprole in the form of a suspension concentrate, emulsifiable concentrate or any other suitable liquid formulation that can coat the seed or plant or plant propagation material.

In yet another aspect the present invention provides use of flonicamid and cyantraniliprole to improve vigour of plant by applying flonicamid and cyantraniliprole one or more agrochemicals to said plant or plant propagation material or the locus thereof, wherein an effective amount of flonicamid and cyantraniliprole is used.

In another aspect the present invention provides the use of flonicamid and cyantraniliprole and one or more agrochemicals to improve the germination of seed by applying flonicamid and cyantraniliprole to said seed or other plant propagation material or the locus thereof wherein an effective amount of flonicamid and cyantraniliprole is used.

In another embodiment, the use of flonicamid and cyantraniliprole to enhance the plant growth or germination or vigour is provided by coating the seed or plant or plant propagation material with flonicamid and cyantraniliprole. Improving germination of seeds comprises improving seed vigour of a plant.

In the practice of the present invention, flonicamid and cyantraniliprole may be employed in the form of technical material or in the form of any standard agriculturally acceptable formulation thereof.

In an embodiment, a seed or plant or plant propagation material is contacted with flonicamid and cyantraniliprole in the form of a suspension concentrate, emulsifiable concentrate or any other suitable liquid formulation that can coat the seed or a plant or a plant propagation material.

Example of such agrochemical liquid formulations include suspension concentrate (SC), emulsifiable concentrate (EC), flowable concentrate (FS), Microemulsion (ME), Oil dispersion (OD), Suspoemulsion (SE) and the like.

In an embodiment, a suspension concentrate (SC) formulation of flonicamid combination may be used.

In preferred embodiment, flowable concentrate (FS) formulation of flonicamid combination may be used.

In an embodiment, the pesticide, herbicide, fungicide, insecticide or acaricide is a suspension concentrate or a flowable concentrate formulation.

In an embodiment, the individual components of the combination of the present invention may be applied to the locus either simultaneously or sequentially, such that flonicamid and one or more agrochemicals may be applied in a tank mix or as a pre-mixed composition.

In an embodiment, the agrochemical composition for improving plant growth comprises flonicamid, one or more agrochemicals, and one or more excipients.

In another embodiment, said one or more agrochemicals comprise pesticides, fungicides, insecticides, and herbicides. In a preferred embodiment, said one or more agrochemicals comprise a fungicide or an insecticide.

In another preferred embodiment, the fungicide is selected from the group consisting of metalaxyl, metalaxyl-M, flutolanil, oxycarboxin, carboxin, fluindapyr, fluxapyroxad, inpyrfluxam, fludioxonil, difenoconazole, ipconazole, triflumizole, prothioconazole, tebuconazole, fenpicoxamid, and cyazofamid.

In another preferred embodiment, the insecticide is selected from the group consisting of chlorantraniliprole, cyantraniliprole, deltamethrin, and bifenthrin.

In another preferred embodiment, flonicamid is present in an amount ranging from 10% to 70% w/w, said one or more agrochemicals are present in an amount ranging from 0.1% to 30% w/w and said one or more agriculturally acceptable excipients are present in an amount ranging from 1% to 30% w/w of total weight of the composition.

In another preferred embodiment, flonicamid is present in an amount ranging from 10% to 50% w/w, said one or more agrochemicals are present in an amount ranging from 0.1% to 20% w/w and said one or more agriculturally acceptable excipients are present in an amount ranging from 1% to 30% w/w of total weight of the composition.

In another preferred embodiment, flonicamid is present in an amount ranging from 20% to 40% w/w, said one or more agrochemicals are present in an amount ranging from 0.1% to 10% w/w and said one or more agriculturally acceptable excipients are present in an amount ranging from 1% to 30% w/w of total weight of the composition.

In another preferred embodiment, flonicamid is present in an amount of 36% w/w, said one or more agrochemicals are present in an amount of 2.5% w/w and said one or more agriculturally acceptable excipients are present in an amount ranging from 1% to 30% w/w of total weight of the composition.

In another preferred embodiment, flonicamid is present in an amount of 36% w/w, fludioxonil is present in an amount of 2.5% w/w and said one or more agriculturally acceptable excipients are present in an amount ranging from 1% to 30% w/w of total weight of the composition.

In another preferred embodiment, flonicamid is present in an amount of 36% w/w, ipconazole is present in an amount of 2.5% w/w and said one or more agriculturally acceptable excipients are present in an amount ranging from 1% to 30% w/w of total weight of the composition.

In another preferred embodiment, flonicamid is present in an amount of 24% w/w, chlorantraniliprole is present in an amount of 12% w/w and said one or more agriculturally acceptable excipients are present in an amount ranging from 1% to 30% w/w of total weight of the composition.

In another preferred embodiment, flonicamid is present in an amount of 24% w/w, chlorantraniliprole is present in an amount of 24% w/w and said one or more agriculturally acceptable excipients are present in an amount ranging from 1% to 30% w/w of total weight of the composition.

In another preferred embodiment, flonicamid is present in an amount of 24% w/w, carboxin is present in an amount of 20% w/w and said one or more agriculturally acceptable excipients are present in an amount ranging from 1% to 30% w/w of total weight of the composition.

In another preferred embodiment, flonicamid is present in an amount of 24% w/w, metalaxyl is present in an amount of 50% w/w and said one or more agriculturally acceptable excipients are present in an amount ranging from 1% to 30% w/w of total weight of the composition.

In another preferred embodiment, flonicamid is present in an amount of 24% w/w, cyantraniliprole is present in an amount of 12% w/w and said one or more agriculturally acceptable excipients are present in an amount ranging from 1% to 30% w/w of total weight of the composition.

In a preferred embodiment, the composition is present in a form of suspension concentrate, flowable concentrate or any suitable liquid formulation.

In an embodiment the formulation includes a non-ionic surfactant and an anionic surfactant.

In an embodiment of the present invention, non-ionic surfactant is selected from the group comprising of non-ionic surfactants such as polyalkyleneoxide siloxanes, ethoxylated derivatives of fatty alcohols, alkyl glucosides, alkyl phenols, polyalkylene glycol ethers and condensation products of alkyl phenols, amines, fatty acids, fatty esters, mono-, di-, or triglycerides, various block copolymeric surfactants derived from alkylene oxides such as ethylene oxide (EO)/propylene oxide (PO), aliphatic amines or fatty acids with ethylene oxides and/or propylene oxides such as the ethoxylated alkyl phenols or ethoxylated aryl or polyaryl phenols, carboxylic esters solubilized with a polyol or polyvinyl alcohol/polyvinyl acetate copolymers, polyvinyl alcohol, polyvinyl pyrrolidinones and acrylic acid graft copolymers and mixtures, reaction products, and/or copolymers thereof.

In a preferred embodiment, non-ionic surfactant of surfactant mix is selected from the group comprising of non-ionic surfactants such as various block copolymeric surfactants derived from alkylene oxides such as ethylene oxide/propylene oxide, aliphatic amines or fatty acids with ethylene oxides and/or propylene oxides such as the ethoxylated alkyl phenols or ethoxylated aryl or polyaryl phenols, their mixtures, reaction products, and/or copolymers thereof.

In an embodiment, the composition comprises from about 0.1% to about 50% w/w and preferably from about 1% to about 40% w/w non-ionic surfactant of the total weight of the agrochemical composition.

In an embodiment, anionic surfactant is selected from the group comprising of alkyl and aryl sulfates and sulfonates, including sodium alky sulfates, sodium mono- and di-alkyl naphthalene sulfonates, sodium alpha-olefin sulfonate, lignin and its derivatives (such as lignosulfonate salts, sodium lignosulfonate), sodium alkane sulfonates, polyoxyalkyene alkylether sulfate, polyoxyalkylene alkylaiyl ether sulfates, polyoxy-alkylene styrylphenyl ether sulfate, mono- and di-alkylbenzene sulfonates, alkylnaphthalene sulfonate, alkylnaphthalene sulfonate formaldehyde condensate, alkyl diphenylether sulfonates, olefme sulfonates, alkylphosphates, polyoxyalkylene alkyl phosphates, polyoxyalkylene phenylether phosphate, polyoxyalkylphenol phosphates, poly-carboxylates, fatty acids and salts thereof, alkyl glycinates, sulfonated methyl esters, sulfonated fatty acids, sulfosuccinates and their derivatives, acyl glutamates, acyl sarcosinates, alkyl sulfoacetates, acylated peptides, alkyl ether carboxylates, acyl lactylates, anionic fluorosurfactants, amid ether sulfates, N-methyl fatty acid taurides, mixtures thereof and the like, including sodium, potassium, ammonium and amine salts, etc. or mixtures thereof.

In a preferred embodiment, anionic surfactant is selected from the group comprising of alkyl and aryl sulfates and sulfonates, including sodium alky] sulfates, sodium mono- and di-alkyl naphthalene sulfonates, lignin, and its derivatives (such as lignosulfonate salts), polyoxyalkyene alkylether sulfate, alkylnaphthalene sulfonate, alkylnaphthalene sulfonate formaldehyde condensate.

In an embodiment, the composition comprising from about 0.1% to about 50% w/w and preferably from about 1% to about 40% w/w anionic surfactant of the total weight of composition.

In an embodiment the composition may further comprise one or more antifreeze agent, wetting agents, fillers, surfactants, anticaking agents, pH-regulating agents, preservatives, biocides, antifoaming agents, colorants and other formulation aids.

In an embodiment, the composition may further comprise one or more agriculturally acceptable excipients selected from the group consisting of surfactants, antifreeze agent, wetting agent, antifoaming agent, thickening agent, preservative, colorant, filler, and combinations thereof.

Suitable antifreeze agents that can be added to the agrochemical composition are liquid polyols, for example ethylene glycol, propylene glycol or glycerol.

Wetting agents that can be added to the agrochemical composition of the present invention include, but are not limited to: polyarylalkoxylated phosphate esters and their potassium salts (e.g., Soprophor® FLK, Stepfac™ TSP PE-K. Other suitable wetting agents include sodium dioctylsulfosuccinates (e.g., Geropon® SDS, Aerosol® OT) and ethoxylated alcohols (e.g., Trideceth-6, Rhodasurf® BC 610, and Tersperse® 4894).

Optionally, about 0.1% to about 5.0% w/w of antifoaming or defoamers are employed to stop any unwanted foam generated while manufacturing highly concentrated liquid biocide dispersion composition. The preferred antifoaming agent is selected from the group of silicone-based compounds, alcohols, glycol ethers, mineral spirits, acetylene diols, polysiloxanes, organosiloxanes, siloxane glycols, reaction products of silicon dioxide and organosiloxane polymer, polydimethylsiloxanes or polyalkylene glycols alone or in combination. Defoamers that are suitable include SAG™ Antifoams (e.g., SAG-10; SAG-1000AP; SAG-1529; SAG-1538; SAG-1571; SAG-1572; SAG-1575; SAG-2001; SAG-220; SAG-290; SAG-30; SAG-30E; SAG-330; SAG-47; SAG-5440; SAG-7133 and SAG-770).

Examples of thickening agents based on anionic heteropolysaccharides from the xanthan gum group are inter alia the Rhodopol 23®, Rhodopol G®, Rhodopol 50 MD®, Rhodicare T®, Kelzan®, Kelzan S® and Satiaxane CX91®.

Preservatives used may be benzisothiazolinone (Proxel™ GXL) or phonols, 2-bromo-2-nitropropane-1,3-diol (Bioban™ BP 30), 5-chloro-2-methyl-4-isothiazolin-3-one & 2 methyl-4-isothiazolin-3 one (Kathon™ CG/ICP), Glutaraldehyde (Ucarcide™ 50), Chloromethylisothiazolinone (CMIT)/Methylisothiazolinone (MIT) (Isocil™ Ultra 1.5), 2.2-dibromo-3-nitrilopropioamide (Reputain™ D20), Natamycin & Nisin, Bronopol/CMIT/MIT (Mergal® 721K3).

Suitable colorants (for example in red, blue and green) are, preferably, pigments, which are sparingly soluble in water, and dyes, which are water-soluble. Examples are inorganic coloring agents (for example iron oxide, titanium oxide, and iron hexacyanoferrate) and organic coloring agents (for example alizarin, azo and phthalocyanin coloring agents).

Fillers may include an organic or inorganic solid inert substance such as talc, clay, diatomaceous earth, magnesium aluminum silicate, white carbon black, pyrophyllite, light calcium carbonate, high clay, organic bentonite, etc., or mixtures thereof.

As used herein the phrase “improving the vigour” of a plant relates to an increase or improvement of the vigour rating, or the stand (the number of plants per unit of area), or the plant height, or the plant canopy, or the visual appearance (such as greener leaf colour), or the root rating, or emergence, or protein content, or increased tillering, or bigger leaf blade, or less dead basal leaves, or stronger tillers, or less fertilizer needed, or less seeds needed, or more productive tillers, or earlier flowering, or early grain maturity, or less plant verse, or increased shoot growth, or earlier germination, or combination of these factors, or other advantages known to a skilled person, by a measurable or noticeable amount over the same factor of the plant produced under the same conditions, but without the application of the subject method.

In an embodiment, the method of the present invention provides one, or more than one, or all of these advantages by applying flonicamid to either the plant, or to the plant propagation material, or to the locus of plant growth or intended plant growth.

Particularly, when it is said that the present method is capable of “improving the yield and/or vigour” of a plant, the present method results in an increase in either the yield, as described above, or the vigour of the plant, as described above, or both the yield and the vigour of the plant.

In accordance with the present invention, an “improvement in plant vigour” means that certain traits are improved qualitatively or quantitatively when compared with the same trait in a control plant which has been grown under the same conditions in the absence of the method of the invention. Such traits include, but are not limited to, early and/or improved germination, improved emergence, the ability to use less seeds, increased root growth, a more developed root system, increased root nodulation, increased shoot growth, increased tillering, stronger tillers, more productive tillers, increased or improved plant stand, less plant verse (lodging), an increase and/or improvement in plant height, an increase in plant weight (fresh or dry), bigger leaf blades, greener leaf colour, increased pigment content, increased photosynthetic activity, earlier flowering, longer panicles, early grain maturity, increased seed, fruit or pod size, increased pod or ear number, increased seed number per pod or ear, increased seed mass, enhanced seed filling, less dead basal leaves, delay of senescence, improved vitality of the plant, increased levels of amino acids in storage tissues and/or less inputs needed (e.g. less fertiliser, water and/or labour needed). A plant with improved vigour may have an increase in any of the aforementioned traits or any combination or two or more of the aforementioned traits.

In accordance with the present invention, an “improvement in plant quality” means that certain traits are improved qualitatively or quantitatively when compared with the same trait in a control plant which has been grown under the same conditions in the absence of the method of the invention. Such traits include, but are not limited to, improved visual appearance of the plant, reduced ethylene (reduced production and/or inhibition of reception), improved quality of harvested material, e.g., seeds, fruits, leaves, vegetables (such improved quality may manifest as improved visual appearance of the harvested material) and the like.

The compositions of present invention may be applied to the locus of the plant on one or more occasions during the growth of the plant. It can be applied to the planting site before the seed is sown, during the sowing of the seed, pre-emergence and/or post-emergence. The compositions can also be used while the plant is being grown in a green house and the use can be continued after transplantation. The soil may, for example, be treated directly, prior to transplanting, at transplanting or after transplanting. The use of the compositions can be via any suitable method, which ensures that the agents penetrate the soil, for example, nursery tray application, in furrow application, soil drenching, soil injection, drip irrigation, application through sprinklers or central pivot, incorporation into soil (broad cast or in band) are such methods.

The treatment according to the invention of the plants and plant parts with the active compound or its compositions is carried out directly or by action on their surroundings, habitat or storage space using customary treatment methods, for example by dipping, spraying, atomizing, irrigating, evaporating, dusting, fogging, broadcasting, foaming, painting, spreading-on, watering (drenching), drip irrigating and, in the case of propagation material, in particular in the case of seeds, furthermore as a powder for dry seed treatment, a solution for seed treatment, a water-soluble powder for slurry treatment, by incrusting, by coating with one or more layers, etc. It is furthermore possible to apply the active compound in combination with other active(s) by the ultra-low volume method, or to inject the active compound combination into the soil.

The rate and frequency of use of the compositions on the plant may vary within wide limits and depends on the type of use, the specific active agents, the nature of the soil, the method of application (pre- or post-emergence, etc.), the plant, the prevailing climatic conditions, and other factors governed by the method of application, the time of application and the target plant.

In an embodiment, when employed in plant protection, the amount of active substance applied is in the range, depending on the kind of effect desired, from 0.001 to 10 kg per ha, preferably from 0.001 to 5 kg per ha or 0.001 to 2 kg per ha preferably from 0.005 to 1 kg per ha, in particular from 0.005 to 0.5 kg per ha.

Accordingly, the rates of application of flonicamid may vary, according to the type of crop, the specific active ingredient, the number of active ingredients, type of plant propagation material but is such that the active ingredient(s) is in an effective amount to provide the desired action (such as disease or pest control) and can be determined by trials.

In an embodiment, for seed treatment, application rates of Flonicamid can vary from 0.1 μg to 100 mg, preferably 0.5 μg to 50 mg, more preferably 1 μg to 10 mg, especially 0.1 to 2 mg, of a.i./seed.

In an embodiment, for seed treatment, application rates of the herbicide, fungicide or insecticide can vary from 0.1 μg to 100 mg, preferably 0.5 μg to 50 mg, more preferably 1 μg to 10 mg, especially 0.1 to 2 mg, of a.i./seed.

In an embodiment of each aspect, application rate of flonicamid is from 0.2 to 1.5 mg a.i./seed, especially on a cotton seed.

In an embodiment of each aspect, application rate of flonicamid is from 0.2 to 1.5 mg a.i./seed, especially on a corn seed.

Preferably, the amount of agrochemicals or other ingredients used in the seed treatment should not inhibit generation of the seed or cause phytotoxic damage to the seed.

In an embodiment, the seed, which is treated with flonicamid, and one or more agrochemicals is selected from soybean, corn, cotton or okra.

In an embodiment the present treatment is applied to paddy, transplanted rice or directly sown rice.

In an embodiment, the present treatment comprises applying a combination of flonicamid and one or more agrochemicals in a range of 1-30 ml/kg seed.

In an embodiment, the present treatment comprises applying a combination of flonicamid and one or more agrochemicals in a range of 1-20 ml/kg seed.

In an embodiment, the present treatment comprises applying a combination of flonicamid and one or more agrochemicals in a range of 1-15 ml/kg seed.

In an embodiment, the present treatment comprises applying a combination of flonicamid and one or more agrochemicals in a range of 1-12 ml/kg seed.

In an embodiment, the present treatment comprises applying a combination of flonicamid and one or more agrochemicals at 10 ml/kg seed.

In an embodiment, the present treatment comprises applying a combination of flonicamid and one or more agrochemicals at 5 ml/kg seed.

In an embodiment, the coating of the plant or plant propagation material or seed can be done by any method known in the art.

In a preferred embodiment the plant or plant propagation material or seed is sown or planted in the soil or pots or nurseries.

In a preferred embodiment the sowing of plant or plant propagation material or seed is done by line sowing.

The seed treatment composition can also comprise or may be applied together and/or sequentially with further active compounds. These further compounds can be selected from fertilizers or micronutrient donors or microorganisms or other preparations that influence plant growth, such as inoculants (e.g., a strain of nitrogen-fixing bacteria), plant inducers.

In an embodiment, the method of the present invention increases the disease resistance in a plant or plant propagation material.

The plant propagation material treated with flonicamid and one or more agrochemicals, pesticides, herbicides, or fungicides in the first aspect are, therefore, resistant to disease and/or pest damage; accordingly, the present invention also provides a pathogenic and/or pest resistant plant propagation material which is treated with flonicamid and one or further active compounds and consequently at least the active ingredients thereof are adhered on the propagation material, such a seed.

Therefore, in yet another embodiment, the present invention provides a plant treated with flonicamid and one or more agrochemicals.

In yet another embodiment, the present invention provides a plant treated with flonicamid and one or more agrochemicals, such that at least a portion of the applied flonicamid and one or more agrochemicals is adhering to the plant or a portion thereof.

In yet another embodiment, the present invention provides a plant propagation material treated with flonicamid and one or more agrochemicals.

In an embodiment, the present invention provides a plant propagation material treated with flonicamid and one or more agrochemicals, such that at least a portion of the applied flonicamid and one or more agrochemicals is adhering to the plant propagation material.

In an embodiment, the plant propagation material is a seed.

Thus, in an embodiment, the present invention provides a seed treated with flonicamid.

In another embodiment, the present invention provides a seed treated with flonicamid, such that at least a portion of the applied flonicamid is adhering to a plant propagation material.

In an embodiment, the seed may be a fruit seed or vegetable seed.

In an embodiment, the choice of the selected seed is not limiting.

In an embodiment, the seed may be selected from soybean seed, orange seed, raspberries seed, broccoli seed, prune seed, corn seed, peach seed, mango seed, celery seed, conifer seed, tangerine seed, kiwifruit seed, gooseberry seed, plum seed, pumpkin seed, beet seed, starfruit seed, bean seed, carrot seed, asparagus seed, apple seed, crab-apple seed, Swiss chard seed, and many more.

Therefore, in yet another embodiment, the present invention provides a corn plant treated with flonicamid and one or more agrochemicals.

In yet another embodiment, the present invention provides a corn plant treated with flonicamid and one or more agrochemicals, such that at least a portion of the applied flonicamid and one or more agrochemicals is adhering to the corn plant or to a portion thereof.

In yet another embodiment, the present invention provides a corn plant propagation material treated with flonicamid and one or more agrochemicals.

In an embodiment, the present invention provides a corn plant propagation material treated with flonicamid and one or more agrochemicals, such that at least a portion of the applied flonicamid and one or more agrochemicals is adhering to the corn plant propagation material.

In an embodiment, the corn plant propagation material is a corn seed.

Thus, in an embodiment, the present invention provides a corn seed treated with flonicamid and one or more agrochemicals.

In another embodiment, the present invention provides a corn seed treated with flonicamid and one or more agrochemicals, such that at least a portion of the applied flonicamid and one or more agrochemicals is adhering to the corn seed.

In yet another embodiment, the present invention provides a locus treated with flonicamid and one or more agrochemicals, wherein the locus is planted with or intended to be planted with a plant or a plant propagation material.

In another embodiment, the present invention provides a method of treating a locus comprising applying flonicamid and one or more agrochemicals to the locus which is planted with or intended to be planted with a plant or a plant propagation material.

The present invention is also directed to a seed that is protected against multiple insect pests comprising a seed treated with composition of flonicamid and one or more agrochemicals. Advantageously the present compositions provide significant efficacy on insect pest and simultaneously provide improvement in plant growth.

In a preferred embodiment, the present invention provides a method for controlling pests by applying an agrochemical combination comprising flonicamid and one or more agrochemicals, simultaneously or sequentially, to a plant or a locus thereof or a plant propagation material thereof.

In a preferred embodiment, the present invention provides a method for controlling pests by applying an agrochemical composition comprising flonicamid and one or more agrochemicals, simultaneously or sequentially, to a plant or a locus thereof or a plant propagation material thereof.

In a preferred embodiment, the present invention provides a method for controlling pests like Spodoptera frugiperda (fall armyworm) by applying an agrochemical combination comprising flonicamid and one or more agrochemicals, simultaneously or sequentially, to a plant or a locus thereof or a plant propagation material thereof.

In a preferred embodiment, the present invention provides a method for controlling pests like Spodoptera frugiperda (fall armyworm) by applying an agrochemical composition comprising flonicamid and one or more agrochemicals, simultaneously or sequentially, to a plant or a locus thereof or a plant propagation material thereof.

In an embodiment, the insect pest may be from Lepidopteran, Coleopteran, Hemipteran, or Homopteran species. However, the choice of the target insect pests is not limiting.

In an embodiment, Lepidopteran pest species which negatively impact agriculture include, but are not limited to, Achoea janata, Adoxophyes spp., Adoxophyes orana, Agrotis spp. (cutworms), Agrotis ipsilon (black cutworm), Alabama argillacea (cotton leafworm), Amorbia cuneana, Amyelosis transitella (navel orangeworm), Anacamptodes defectaria, Anarsia lineatella (peach twig borer), Anomis sabulifera (jute looper), Anticarsia gemmatalis (velvet bean caterpillar), Archips argyrospila (fruittree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leafperforator), Caloptilia spp. (leaf miners), Capua reticulana, Carposina niponensis (peach fruit moth), Chilo spp., Chlumetia transversa (mango shoot borer), Choristoneura rosaceana (obliquebanded leafroller), Chrysodeixis spp., Cnaphalocerus medinalis (grass leafroller), Colias spp., Conpomorpha cramerella, Cossus cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraca spp. (stalk borers), Diatraea saccharalis (sugarcane borer), Diatraca graniosella (southwester corn borer), Earias spp. (bollworms), Earias insulata (Egyptian bollworm), Earias vitella (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobbaco moth), Ephestia kuchniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicata (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparana (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaca operculella (potato tuber moth), Phyllocnisitis citrella, Phyllonorycter spp. (leafminers), Pieris rapae (imported cabbageworm), Plathypena scabra, Plodia interpunctella (Indian meal moth), Plutella xylostella (diamondback moth), Polychrosis viteana (grape berry moth), Prays endocarpa, Prays oleae (olive moth), Pseudaletia spp. (noctuid moths), Pseudaletia unipunctata (armyworm), Pseudoplusia includens (soybean looper), Rachiplusia nu, Scirpophaga incertulas, Sesamia spp. (stemborers), Sesamia inferens (pink rice stem borer), Sesamia nonagrioides, Setora nitens, Sitotroga cerealella (Angoumois grain moth), Sparganothis pilleriana, Spodoptera spp. (armyworms), Spodoptera exigua (beet armyworm), Spodoptera frugiperda (fall armyworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer) and Zeuzera pyrina (leopard moth).

In yet another embodiment, the insect pests are of the order Orthoptera, such as Anabrus simplex (Mormon cricket), Gryllotalpidae (mole crickets), Locusta migratoria, Melanoplus spp. (grasshoppers), Microcentrum retinerve (angularwinged katydid), Pterophylla spp. (kaydids), chistocerca gregaria, Scudderia furcata (forktailed bush katydid) and Valanga nigricorni.

In yet another embodiment, the insect pests are of the order Thysanoptera, such as Frankliniella fusca (tobacco thrips), Frankliniella occidentalis (western flower thrips), Frankliniella shultzei Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis and Thrips spp.

In an embodiment Coleopteran insect pests may be selected from but not limited to Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp, Cerotoma spp. (chrysomeids), Cerotoma trifurcata (bean leaf beetle), Ceutorhynchus spp. (weevils), Ceutorhynchus assimilis (cabbage seedpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes lardarius (larder beetle), Dermestes maculates (hide beetle), Diabrotica spp. (chrysolemids), Epilachna varivestis (Mexican bean beetle), Faustinus cubae, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys futscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha melolontha (common European cockchafer), Oberea brevis, Oberea linearis, Oryctes rhinoceros (date palm beetle), Oryzaephilus mercator (merchant grain beetle), Oryzaephilus surinamensis (sawtoothed grain beetle), Otiorhynchus spp. (weevils), Oulema melanopus (cereal leaf beetle), Oulema oryzae, Pantomorus spp. (weevils), Phyllophaga spp. (May/June beetle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (Eurpoean chafer), Rhynchophorus spp. (weevils), Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle) and Zabrus tenebioides.

In an embodiment, the insect pests are of the order Hemiptera, such as Acrosternum hilare (green stink bug), Blissus leucopterus (chinch bug), Calocoris norvegicus (potato mind), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus hesperus (western tarnished plant bug), Maconellicoccus hirsutus, Neurocolpus longirostris, Nezara viridula (southern green stink bug), Paratrioza cockerelli, Phytocoris spp. (plant bugs), Phytocoris californicus, Phytocoris relativus, Piezodorus guildingi, Poecilocapsus lineatus (fourlined plant bug), Psallus vaccinicola, Pseudacysta perseae, Scaptocoris castanea and Triatoma spp. (bloodsucking conenose bugs/kissing bugs).

In an embodiment, the insect pests are of the order Homoptera, such as Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella, Aphrophora spp. (leafhoppers), Aonidiella aurantii (California red scale), Aphis spp. (aphids), Aphis gossypii (cotton aphid), Aphis pomi (apple aphid), Aulacorthum solani (foxglove aphid), Bemisia spp. (whiteflies), Bemisia argentifolii, Bemisia tabaci (sweet potato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red bawax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchasi (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphi (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissetia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale) and Zulia entreriana.

In an embodiment, the present invention provides a method of treating a corn seed, wherein at least 98% of the sown seeds are germinated within 10 days of sowing.

In a further embodiment, the present invention relates to combinations of flonicamid which exhibit synergistic effect on the seeds treated with the flonicamid combinations. The different combinations improve the percentage germination of seeds along with enhanced shoot length, root length and biomass of the plants.

In view of the above, it will be seen that the several advantages of the invention are achieved, and other advantageous results attained.

Although the present invention has been disclosed in full, it will be understood that numerous additional modifications and variations could be made thereto without departing from the scope of the invention.

### EXAMPLES

The present invention is ascertained by the experiments as exemplified further. These examples are merely illustrations and are not to be understood as limiting the scope and underlying principles of the invention in any way. Indeed, various modifications of the invention in addition to those shown and described herein will be apparent to those skilled in the art from the following examples and foregoing description.

### Example 1

### Composition—Flonicamid 500 g/L Flowable Concentrate (FS)

| | | Quantity |
|---|---|---|
| No. | Ingredients | (% w/w) |
| 1 | Flonicamid | 42.5 |
| 2 | EO-PO block copolymer | 1.5 |
| 3 | Sodium lignosulfonate | 2.5 |
| 4 | Precipitate silica | 1.0 |
| 5 | Hydrotreated light paraffinic distillate | 5 |
| 6 | Propylene glycol | 8.5 |
| 7 | Organic Azo Pigment | 1.0 |
| 8 | Xanthan gum | 0.05 |
| 9 | 1,2-Benzisothiazolin-3-one | 0.10 |
| 10 | Acetic acid | 0.08 |
| 11 | Non-ionic aqueous emulsion of | 0.2 |
| | polydimethylsiloxane | |
| 12 | Water | Q.S. |

| | |
|---|---|
| Total | 100.00 |

### Process for Preparation

Flonicamid, EO-PO block copolymer, sodium lignosulfonate, precipitated silica, hydrotreated light paraffinic distillate, propylene glycol, organic azo pigment, xanthan gum, 1,2-Benzisothiazolin-3-one, acetic acid, and non-ionic aqueous emulsion of polydimethylsiloxane were mixed in water in required quantities in a homogenizer. Homogenization was carried out for 20 minutes to obtain a homogenized mixture. The homogenized mixture was fed to the wet grinding mill for particle size reduction. The uniform mixture thus obtained in milling was then transferred to gellification vessel containing pre-formulated 2% gel obtained by mixing 0.2 g xanthan gum in 10 ml water to obtain flowable concentrate of flonicamid.

### Example 2

### Composition—Flonicamid Combination 500 g/L (FS)

| | | Quantity |
|---|---|---|
| No. | Ingredients | (% w/w) |
| 1 | Flonicamid | 36 |
| 2 | One or more agrochemicals | 2.5 |
| 3 | EO/PO block copolymer | 1.5 |
| 4 | Sodium lignosulfonate | 2.5 |
| 5 | Precipitate silica | 1.0 |
| 6 | Hydrotreated light paraffinic | 5 |
| | distillate | |
| 7 | Propylene glycol | 8.5 |
| 8 | Organic Azo Pigment | 1.0 |
| 9 | Xanthan gum | 0.05 |
| 10 | 1,2-Benzisothiazolin-3-one | 0.10 |
| 11 | Acetic acid | 0.08 |
| 12 | Non-ionic aqueous emulsion of | 0.2 |
| | polydimethylsiloxane | |
| 13 | Water | Q.S. |

| | |
|---|---|
| Total | 100.00 |

### Process for Preparation

Flonicamid, one or more agrochemicals, EO-PO block copolymer, sodium lignosulfonate, precipitated silica, hydrotreated light paraffinic distillate, propylene glycol, organic azo pigment, xanthan gum, 1,2-Benzisothiazolin-3-one, acetic acid, and non-ionic aqueous emulsion of polydimethylsiloxane were mixed in water in required quantities in a homogenizer. Homogenization was carried out for 20 minutes to obtain a homogenized mixture. The homogenized mixture was fed to the wet grinding mill for particle size reduction. The uniform mixture thus obtained in milling was then transferred to gellification vessel containing pre-formulated 2% gel obtained by mixing 0.2 g xanthan gum in 10 ml water to obtain flowable concentrate of flonicamid combination.

Furthermore, one or more agrochemicals are selected from a group comprising ipconazole, fludioxonil, carboxin, metalaxyl, chlorantraniliprole and cyantraniliprole.

### Example 3

### Evaluation of the Seed Treatment of Corn Seeds Using a Combination of Flonicamid and Fludioxonil

5 kg of untreated clean seeds of Zea mays were collected. The seeds were mixed thoroughly in a tray to make them homogeneous. 25 sub-samples of 200 grams (g) each were prepared. A polythene bag was used for the treatment of each sample with flonicamid and fludioxonil. The formulation was used at a dosage of 5 ml/kg of seed and 10 ml/kg of seed. Before treating the seeds were checked for their initial moisture content. After the treatment, the treated seeds were dried in a shade/hot air chamber having temperature of 40-43° C. to maintain their original moisture content. The observations are made within 10 days of sowing seeds. Table 1 discloses the growth parameters observed on treatment of corn seeds in paper towel seed germination tests

TABLE 1
Growth parameters observed in paper towel seed germination tests

Components
Flonicamid + Fludioxonil
(36% + 2.5% w/w)

| Growth factors | 5 ml/kg seed | 10 ml/kg seed |
|---|---|---|
| Shoot length (cm) | 23.115 | 21.415 |
| Germination (%) | 94 | 92 |
| Root length (cm) | 10.515 | 11.16 |
| Fresh weight (g) | 25.625 | 24.33 |

Table 2 discloses the growth parameters observed on treatment of corn seeds in cocopeat tray test.

TABLE 2
Growth parameters observed in cocopeat tray test

Components
Flonicamid + Fludioxonil
(36% + 2.5% w/w)

| Growth factors | 5 ml/kg seed | 10 ml/kg seed |
|---|---|---|
| Shoot length (cm) | 18.11 | 17.6 |
| Germination (%) | 94 | 100 |

From the results disclosed in Tables 1 and 2, it is evident that growth parameters of the corn seeds have been enhanced/improved on application of the present combination of flonicamid and fludioxonil to the corn seeds.

### Example 4

### Evaluation of the Seed Treatment of Corn Seeds Using a Combination of Flonicamid and Ipconazole

5 kg of untreated clean seeds of Zea mays were collected. The seeds were mixed thoroughly in a tray to make them homogeneous. 25 sub-samples of 200 g each were prepared. A polythene bag was used for the treatment of each sample with Flonicamid and Ipconazole. The formulation was used at a dosage of 5 ml/kg of seed and 10 ml/kg of seed. Before treating the seeds were checked for their initial moisture content. After the treatment, the treated seeds were dried in a shade/hot air chamber having temperature of 40-43° C. to maintain their original moisture content. The observations are made within 10 days of sowing seeds. Table 3 discloses the growth parameters observed on treatment of corn seeds in paper towel seed germination tests.

TABLE 3
Growth parameters observed in paper towel seed germination tests

Composition
Flonicamid + Ipconazole
(36% + 2.5% w/w)

| Growth factors | 5 ml/kg seed | 10 ml/kg seed |
|---|---|---|
| Shoot length (cm) | 23.585 | 20.025 |
| Germination (%) | 96 | 94 |
| Root length (cm) | 12.55 | 13.05 |
| Fresh weight (g) | 28.145 | 25.23 |

Table 4 discloses the growth parameters observed on treatment of corn seeds in cocopeat tray test.

TABLE 4
Growth parameters observed in cocopeat tray test

Composition
Flonicamid + Ipconazole
(36% + 2.5% w/w)

| Growth factors | 5 ml/kg seed | 10 ml/kg seed |
|---|---|---|
| Shoot length (cm) | 18.73 | 17.97 |
| Germination (%) | 98 | 98 |

From the results disclosed in Tables 3 and 4, it is evident that the growth parameters of the corn seeds have been enhanced/improved on application of the present combination of flonicamid and ipconazole to the corn seeds.

### Example 5

### Evaluation of the Seed Treatment of Corn Seeds Using Various Combinations of Flonicamid

7 kg of untreated clean seeds of Zea mays were collected. The seeds were 5 mixed thoroughly in a tray to make them homogeneous. 21 sub-samples of 300 g each were prepared. A polythene bag was used for the treatment of each sample with flonicamid combinations. The formulation was used at a dosage of 5 ml/kg of seed. Before treating, the seeds were checked for their initial moisture content and minimum germination percentage. After the treatment, the treated seeds were dried in a hot air chamber having temperature of 40-43° C. to maintain their original moisture content. Table 5 discloses the effect on root length and Table 6 discloses fresh weight of the seedlings.

TABLE 5
Effect of root length observed in corn seeds

| Treatment | Root length (cm) |
|---|---|
| Untreated Control | 14.5 |
| Flonicamid 360 g/L + Ipconazole 25 g/L | 15 |
| Flonicamid 240 g/L + Chlorantraniliprole 240 g/L | 17.5 |
| Flonicamid 360 g/L + Fludioxonil 25 g/L | 23.5 |
| Flonicamid 240 g/L + Carboxin 200 g/L | 19 |
| Flonicamid 240 g/L + Metalayxl 50 g/L | 19 |
| Flonicamid 240 g/L + Cyantraniliprole 120 g/L | 15.5 |
| Flonicamid 360 g/L | 12.5 |
| Fludioxonil 25 g/L | 14 |
| Carboxin 200 g/L | 14.25 |
| Metalayxl 50 g/L | 15 |
| Cyantraniliprole 120 g/L | 14.25 |
| Thiamethoxam | 11.75 |
| Carboxin Thiram | 12.5 |
| Thiamethoxam + Carboxin + Thiram | 8.77 |

TABLE 6
Effect of fresh weight observed in corn seeds

| Treatment | Fresh weight (g) |
|---|---|
| Untreated Control | 22.45 |
| Flonicamid 360 g/L + Ipconazole 25 g/L | 27.26 |
| Flonicamid 240 g/L + Chlorantraniliprole 120 g/L | 24.64 |
| Flonicamid 360 g/L + Fludioxonil 25 g/L | 27.49 |
| Flonicamid 240 g/L + Carboxin 200 g/L | 27.36 |
| Flonicamid 240 g/L + Metalayxl 50 g/L | 26.54 |
| Flonicamid 240 g/L + Cyantraniliprole 120 g/L | 26.41 |
| Flonicamid 360 g/L | 22.73 |
| Metalayxl 50 g/L | 25.72 |
| Cyantraniliprole 120 g/L | 20.92 |
| Thiamethoxam | 19.31 |
| Carboxin Thiram | 26.81 |
| Thiamethoxam + Carboxin + Thiram | 24.58 |

From the results disclosed in Tables 5 and 6, it is evident that the growth parameters of the corn seeds have been enhanced/improved on application of the present combinations of flonicamid to the corn seeds.

### Example 6

### Evaluation of the Seed Treatment of Corn Seeds Using Various Combinations of Flonicamid

Experiment was performed to evaluate the effect of the combination of flonicamid and one or more agrochemicals on percentage germination of corn seeds at 5 days after seeding (DAS), 10 DAS and 15 DAS. The formulation was used at a dosage of 10 ml/kg of seed. Table 7 discloses the percentage germination of corn seeds.

TABLE 7
% Germination of corn seeds

| Sr. | | % Germination of corn seeds | | |
|---|---|---|---|---|
| No. | Type of Combination | 5 DAS | 10 DAS | 15 DAS |
| 1 | Untreated corn seeds | 54.0 | 71.0 | 72.3 |
| 2 | Flonicamid 360 g/l + | 68.7 | 83.7 | 86.0 |
| | Fludioxonil 25 g/l | | | |
| 3 | Flonicamid 360 g/l + | 68.3 | 80.7 | 83.7 |
| | Ipconazole 25 g/l | | | |
| 4 | Flonicamid 240 g/l + | 72.7 | 79.7 | 80.7 |
| | Metalaxyl 50 g/l | | | |
| 5 | Flonicamid 240 g/l + | 79.0 | 81.7 | 82.7 |
| | Chlorantraniliprole 240 g/l | | | |
| 6 | Flonicamid 360 g/ | 64.0 | 72.3 | 78.0 |
| | l_Cyantraniliprole 120 g/ | | | |

From the results disclosed in Table 7, it is evident that the % germination of the corn seeds have been enhanced/improved on application of the present combinations of flonicamid to the corn seeds.

### Example 7

### Evaluation of the Seed Treatment of Corn Seeds Using Various Combinations of Flonicamid

Experiment was performed to evaluate the effect of the combination of flonicamid and one or more agrochemicals on plant height and root length (cm) of corn seeds at 20 and 35 DAS, and plant vigour at 10, 20, 30 and 40 DAS. The formulation was used at a dosage of 10 ml/kg of seed. Table 8 discloses the effect on plant height, root length and plant vigour of corn seeds.

TABLE 8
Plant height, root length and plant vigour of corn seeds

| | | Plant | | Root | | | | | |
|---|---|---|---|---|---|---|---|---|---|
| | | height | | length | | | | | |
| | | (cm) | | (cm) | | Plant vigour (1-5 scale) | | | |
| Sr. | Type of | 20 | 35 | 20 | 35 | 10 | 20 | 30 | 40 |
| No. | Combination | DAS | DAS | DAS | DAS | DAS | DAS | DAS | DAS |
| 1 | Untreated corn | 19.4 | 51.8 | 16.7 | 21.3 | 3.0 | 3.0 | 3.0 | 3.0 |
| | seeds | | | | | | | | |
| 2 | Flonicamid 360 g/l + | 23.1 | 71.1 | 19.0 | 28.9 | 5.0 | 5.0 | 5.0 | 5.0 |
| | Fludioxonil 25 g/l | | | | | | | | |
| 3 | Flonicamid 360 g/l + | 22.4 | 61.8 | 18.6 | 30.3 | 4.0 | 4.7 | 4.3 | 5.0 |
| | Ipconazole 25 g/l | | | | | | | | |
| 4 | Flonicamid 240 g/l + | 22.2 | 66.7 | 17.7 | 30.8 | 5.0 | 5.0 | 5.0 | 5.0 |
| | Metalaxyl 50 g/l | | | | | | | | |
| 5 | Flonicamid 240 g/l + | 23.9 | 68.6 | 20.6 | 30.6 | 4.7 | 5.0 | 5.0 | 5.0 |
| | Chlorantraniliprole | | | | | | | | |
| | 120 g/l | | | | | | | | |
| 6 | Flonicamid 360 | 23.0 | 62.1 | 19.6 | 29.1 | 5.0 | 5.0 | 5.0 | 5.0 |
| | g/l_Cyantraniliprole | | | | | | | | |
| | 120 g/ | | | | | | | | |

From the results disclosed in Table 8, it is evident that the growth parameters of the corn seeds have been enhanced/improved on application of the present combinations of flonicamid to the corn seeds.

### Example 8

### Evaluation of the Effect of Various Combinations of Flonicamid on Percentage Control of Fall Armyworm

Experiment was performed to evaluate the effect of the combination of flonicamid and one or more agrochemicals on percentage control of fall armyworm in corn seeds at 10, 20, 30 and 40 DAS. The formulation was used at a dosage of 10 ml/kg of seed. Table 9 discloses the percentage germination of corn seeds.

TABLE 9
% control of fall armyworm in corn seeds

| Sr. | | % Germination of corn seeds | | | |
|---|---|---|---|---|---|
| No. | Type of Combination | 10 DAS | 20 DAS | 30 DAS | 40 DAS |
| 1 | Untreated corn seeds | 0.7 | 1.1 | 1.2 | 1.3 |
| 2 | Flonicamid 360 + | 27.3 | 34.4 | 834.3 | 30.8 |
| | Fludioxonil 25 | | | | |
| 3 | Flonicamid 360 + | 22.7 | 31.3 | 31.4 | 25.6 |
| | Ipconazole 25 | | | | |
| 4 | Flonicamid 240 + | 18.2 | 21.9 | 20.0 | 17.9 |
| | Metalaxyl 50 | | | | |
| 5 | Flonicamid 240 + | 86.4 | 87.5 | 85.7 | 76.9 |
| | Chlorantraniliprole 240 | | | | |
| 6 | Flonicamid 360 + | 77.3 | 78.1 | 77.1 | 66.7 |
| | Cyantraniliprole 120 | | | | |

From the results disclosed in Table 9, it is evident that the percentage control for fall armyworm in the corn seeds have been enhanced/improved on application of the present combinations of flonicamid to the corn seeds.

### Example 9

### Evaluation of the Germination Index for Various Combinations of Flonicamid in Corn Seeds

7 kg of untreated clean seeds of Zea mays were collected. The seeds were mixed thoroughly in a tray to make them homogeneous. 21 sub-samples of 300 g each were prepared. A polythene bag was used for the treatment of each sample with flonicamid combinations. The formulation was used at a dosage of 5 ml/kg of seed. Before treating, the seeds were checked for their initial moisture content and minimum germination percentage. After the treatment, the treated seeds were dried in a hot air chamber having temperature of 40-43° C. to maintain their original moisture content. Table 10 discloses the germination index of corn seeds by petri dish method.

TABLE 10
Effect of fresh weight observed in corn seeds

| | Germination index | |
|---|---|---|
| Treatment | 4^{th} day | 7^{th} day |
| Untreated Control | 9 | 1 |
| Flonicamid 360 g/L + Ipconazole 25 g/L | 10 | 0 |
| Flonicamid 240 g/L + Chlorantraniliprole 120 g/L | 10 | 0 |
| Flonicamid 360 g/L + Fludioxonil 25 g/L | 10 | 0 |
| Flonicamid 240 g/L + Carboxin 200 g/L | 10 | 0 |
| Flonicamid 240 g/L + Metalayxl 50 g/L | 9 | 1 |
| Flonicamid 240 g/L + Cyantraniliprole 120 g/L | 9 | 1 |
| Flonicamid 360 g/L | 7 | 1 |
| Flonicamid 240 g/L | 7 | 3 |
| Ipconazole 25 g/L | 7 | 3 |
| Metalayxl 50 g/L | 7 | 3 |
| Chlorantraniliprole 120 g/L | 7 | 1 |
| Fludioxonil 25 g/L | 8 | 1 |
| Cyantraniliprole 120 g/L | 7 | 3 |
| Thiamethoxam | 7 | 2 |
| Thiamethoxam + Carboxin + Thiram | 9 | 1 |

From the results disclosed in Table 10, it is evident that the germination index in the corn seeds have been enhanced/improved on application of the present combinations of flonicamid to the corn seeds.

1. An agrochemical combination for improving plant growth, the combination comprising:
flonicamid and one or more agrochemicals; wherein a weight ratio of the flonicamid to said one or more agrochemicals ranges from 1:1 to 100:1.

2. The combination as claimed in claim 1, wherein the weight ratio of the flonicamid to said one or more agrochemicals ranges from 1:1 to 30:1.

3. The combination as claimed in claim 1, wherein the flonicamid is present in a concentration range of 50-500 g/L.

4. The combination as claimed in claim 1, wherein said one or more agrochemicals are present in a concentration range of 10-400 g/L.

5. The combination as claimed in claim 1, wherein said one or more agrochemicals comprise a fungicide or an insecticide.

6. The combination as claimed in claim 5, wherein the fungicide is selected from the group consisting of metalaxyl, metalaxyl-M, flutolanil, oxycarboxin, carboxin, fluindapyr, fluxapyroxad, inpyrfluxam, fludioxonil, difenoconazole, ipconazole, triflumizole, prothioconazole, tebuconazole, fenpicoxamid, and cyazofamid.

7. The combination as claimed in claim 1, wherein the combination comprises the flonicamid and metalaxyl.

8. The combination as claimed in claim 1, wherein the combination comprises the flonicamid and carboxin.

9. The combination as claimed in claim 1, wherein the combination comprises the flonicamid and fludioxonil.

10. The combination as claimed in claim 1, wherein the combination comprises the flonicamid and ipconazole.

11. The combination as claimed in claim 5, wherein the insecticide is selected from the group consisting of chlorantraniliprole, cyantraniliprole, deltamethrin, and bifenthrin.

12. The combination as claimed in claim 1, wherein the combination comprises the flonicamid and chlorantraniliprole.

13. The combination as claimed in claim 1, wherein the combination comprises the flonicamid and cyantraniliprole.

14. Use of an agrochemical combination comprising flonicamid and one or more agrochemicals, for improving plant growth.

15. An agrochemical composition for improving plant growth, the composition comprising:
flonicamid;
one or more agrochemicals; and
at least one agrochemically acceptable excipient.

16. The composition as claimed in claim 15, wherein said one or more agrochemicals comprise a fungicide or an insecticide.

17. The composition as claimed in claim 16, wherein the fungicide is selected from the group consisting of metalaxyl, metalaxyl-M, flutolanil, oxycarboxin, carboxin, fluindapyr, fluxapyroxad, inpyrfluxam, fludioxonil, difenoconazole, ipconazole, triflumizole, prothioconazole, tebuconazole, fenpicoxamid, and cyazofamid.

18. The composition as claimed in claim 16, wherein the insecticide is selected from the group consisting of chlorantraniliprole, cyantraniliprole, deltamethrin, and bifenthrin.

19. The composition as claimed in claim 15, wherein the flonicamid is present in an amount ranging from 10% to 50% w/w of total weight of the composition.

20. The composition as claimed in claim 15, wherein said one or more agrochemicals are present in an amount ranging from 0.1% to 20% w/w of total weight of the composition.

21. The composition as claimed in claim 15, wherein said at least one agrochemically acceptable excipient are present in an amount ranging from 1% to 30% w/w of total weight of the composition.

22. The composition as claimed in claim 15, wherein said at least one agrochemically acceptable excipient are selected from the group consisting of surfactants, antifreeze agent, wetting agent, antifoaming agent, thickening agent, preservative, colorant, filler, and combinations thereof.

23. The composition as claimed in claim 15, wherein the composition is present in a form of a suspension concentrate, a flowable concentrate or a liquid formulation.

24. A method for improving plant growth, the method comprising:
applying an agrochemical combination comprising flonicamid and one or more agrochemicals, simultaneously or sequentially, to a plant or a locus thereof or a plant propagation material thereof.

25. The method as claimed in claim 24, wherein the plant propagation material is a seed.

26. The method as claimed in claim 24, wherein the method comprises coating the seed with a combination of flonicamid and said one or more agrochemicals.

27. The method as claimed in claim 24, wherein said one or more agrochemicals comprise a fungicide or an insecticide.

28. The method as claimed in claim 27, wherein the fungicide is selected from the group consisting of metalaxyl, metalaxyl-M, flutolanil, oxycarboxin, carboxin, fluindapyr, fluxapyroxad, inpyrfluxam, fludioxonil, difenoconazole, ipconazole, triflumizole, prothioconazole, tebuconazole, fenpicoxamid, and cyazofamid.

29. The method as claimed in claim 24, wherein the agrochemical combination further comprises metalaxyl.

30. The method as claimed in claim 24, wherein the agrochemical combination further comprises carboxin.

31. The method as claimed in claim 24, wherein the agrochemical combination further comprises fludioxonil.

32. The method as claimed in claim 24, wherein the agrochemical combination further comprises ipconazole.

33. The method as claimed in claim 27, wherein the insecticide is selected from the group consisting of chlorantraniliprole, cyantraniliprole, deltamethrin, and bifenthrin.

34. The method as claimed in claim 24, wherein the agrochemical combination further comprises chlorantraniliprole.

35. The method as claimed in claim 24, wherein the agrochemical combination further comprises cyantraniliprole.

36. The method as claimed in claim 24, wherein the method comprises applying a composition comprising the combination of flonicamid and one or more agrochemicals in a range of 1-30 ml/kg seed.
